(19) United States
(12) Patent Application Publication
(10) Pub. No.: US 2025/0349191 A1
(43) Pub. Date: Nov. 13, 2025

(54) HAPTICS MEDIA FILE ENCAPSULATION METHOD AND APPARATUS, HAPTICS MEDIA FILE DECAPSULATION METHOD AND APPARATUS, ELECTRONIC DEVICE, STORAGE MEDIUM, PROGRAM PRODUCT

(71) Applicant: Tencent Technology (Shenzhen) Company, Shenzhen (CN)

(72) Inventor: Ying HU, Shenzhen (CN)

(21) Appl. No.: 19/268,837

(22) Filed: Jul. 14, 2025

Related U.S. Application Data
(63) Continuation of application No. PCT/CN2024/091107, filed on May 6, 2024.

(30) Foreign Application Priority Data
May 19, 2023 (CN) 202310578365.1

(51) Int. Cl. G08B 6/00

(52) U.S. Cl. CPC G08B 6/00

(57) ABSTRACT

Embodiments of this application provide a haptics media file encapsulation method performed by an electronic device. The encapsulation method includes: acquiring a haptics media bitstream corresponding to a target haptics media signal; and encapsulating the haptics media bitstream into a haptics media file, the haptics media file including at least two tracks, each track including haptics media data of at least one data type in the haptics media bitstream and first metadata of the haptics media data, the data type being obtained based on a preset data class, and the first metadata indicating the data type of the haptics media data.

### CROSS-REFERENCE TO RELATED APPLICATIONS

This application is a continuation application of PCT Patent Application No. PCT/CN2024/091107, entitled “HAPTICS MEDIA FILE ENCAPSULATION METHOD AND APPARATUS, HAPTICS MEDIA FILE DECAPSULATION METHOD AND APPARATUS, ELECTRONIC DEVICE, STORAGE MEDIUM, PROGRAM PRODUCT” filed on May 6, 2024, which claims priority to Chinese Patent Application No. 202310578365.1, entitled “HAPTICS MEDIA FILE ENCAPSULATION METHOD, HAPTICS MEDIA FILE DECAPSULATION METHOD, AND CORRESPONDING DEVICE” filed with the China National Intellectual Property Administration on May 19, 2023, both of which are incorporated herein by reference in their entirety.

### FIELD OF THE TECHNOLOGY

This application relates to the field of haptics media encoding/decoding technologies, and in particular, to a haptics media file encapsulation method and apparatus, a haptics media file decapsulation method and apparatus, an electronic device, a storage medium, and a program product.

### BACKGROUND OF THE DISCLOSURE

Presentation of immersive media content usually involves various wearable devices or interactive devices. Therefore, in addition to conventional visual and auditory presentations, immersive media further incorporates a new form of presentation namely, haptics presentation. Haptics presentation, enabled by a haptics presentation mechanism that integrates hardware and software, allows a user to receive information through his/her body, providing an embedded bodily sensation and transferring key information about a system being used by the user. For example, a mobile phone vibrates to remind its user that a piece of information is received. Such vibration is a type of haptics presentation. The haptics presentation can enhance auditory and visual presentations, to improve user experience.

When haptics media content is transmitted, similar to audio and video media, a transmitting end needs to encode and encapsulate the haptics media content, and then a receiving end acquires the haptics media content after decapsulation and decoding. However, the related art only supports encapsulating the haptics media content within a single track, which limits flexibility of application of the haptics media content.

### SUMMARY

An objective of this application is to overcome at least one of the foregoing technical defects, embodiments of this application provide the following technical solutions.

In an aspect, the embodiments of this application provide a haptics media file encapsulation method, which includes:
acquiring a haptics media bitstream corresponding to a target haptics media signal; and
encapsulating the haptics media bitstream into a haptics media file,
wherein the haptics media file comprises at least two tracks, each track comprising haptics media data of at least one data type in the haptics media bitstream based on a preset data class and first metadata of the haptics media data indicating the data type of the haptics media data.

In another aspect, the embodiments of this application provide a haptics media file decapsulation method, which includes:
acquiring a haptics media file, the haptics media file including at least two tracks, each track including data of at least one data type in a haptics media bitstream and first metadata of the haptics media data, the data type being obtained based on a preset data class, and the first metadata indicating the data type of the haptics media data; and
determining at least one target track based on the first metadata, and decapsulating the target track to obtain a haptics media bitstream corresponding to each target track.

In another aspect, the embodiments of this application further provide a haptics media file encapsulation apparatus, which includes:
a haptics media bitstream acquiring module, configured to acquire a haptics media bitstream corresponding to a target haptics media signal; and
a haptics media bitstream encapsulating module, configured to encapsulate the haptics media bitstream into a haptics media file,
the haptics media file including at least two tracks, each track including haptics media data of at least one data type in the haptics media bitstream and first metadata of the haptics media data, the data type being obtained based on a preset data class, and the first metadata indicating the data type of the haptics media data.

In another aspect, the embodiments of this application further provide a haptics media file decapsulation apparatus, which includes:
a haptics media file acquiring module, configured to acquire a haptics media file, the haptics media file including at least two tracks, each track including data of at least one data type in a haptics media bitstream and first metadata of the haptics media data, the data type being obtained based on a preset data class, and the first metadata indicating the data type of the haptics media data; and
a haptics media file decapsulating module, configured to determine at least one target track based on the first metadata, and decapsulate the target track to obtain a haptics media bitstream corresponding to each target track.

In another aspect, the embodiments of this application further provide an electronic device, which includes a memory and a processor,
the memory having a computer program stored therein; and
the processor being configured to execute the computer program to implement the haptics media file encapsulation method or the haptics media file decapsulation method.

In another aspect, the embodiments of this application provide an encapsulation device, which includes a memory and a processor,
the memory having a computer program stored therein; and
the processor being configured to execute the computer program to implement the haptics media file encapsulation method.

In another aspect, the embodiments of this application provide a decapsulation device, which includes a memory and a processor,
the memory having a computer program stored therein; and
the processor being configured to execute the computer program to implement the haptics media file decapsulation method.

In a seventh aspect, the embodiments of this application provide a non-transitory computer-readable storage medium, which has a computer program stored therein, a processor executing the computer program to implement the haptics media file encapsulation method or the haptics media file decapsulation method.

In an eighth aspect, the embodiments of this application provide a computer program product or a computer program, which includes computer instructions, the computer instructions being stored in a non-transitory computer-readable storage medium. A processor of a computer device reads the computer instructions from the computer-readable storage medium, and executes the computer instructions, to cause the computer device to implement the haptics media file encapsulation method or the haptics media file decapsulation method.

### BRIEF DESCRIPTION OF THE DRAWINGS

To describe the technical solutions in the embodiments of this application more clearly, the following briefly describes accompanying drawings required for describing the embodiments.

FIG. 1 is a structural diagram of a system for implementing a haptics media file encapsulation method and a haptics media decapsulation method according to an embodiment of this application.

FIG. 2 is a schematic flowchart of a haptics media file encapsulation method according to an embodiment of this application.

FIG. 3 is a schematic diagram of a haptics media file obtained in an example according to an embodiment of this application.

FIG. 4 is a schematic diagram of another haptics media file obtained in an example according to an embodiment of this application.

FIG. 5 is a schematic diagram of a silent sample group in an example according to an embodiment of the present application.

FIG. 6 is a schematic diagram of a second metadata encapsulation manner according to an embodiment of this application.

FIG. 7 is a schematic flowchart of a haptics media file decapsulation method according to an embodiment of this application.

FIG. 8 is a structural block diagram of a haptics media file encapsulation apparatus according to an embodiment of this application.

FIG. 9 is a structural block diagram of a haptics media file decapsulation apparatus according to an embodiment of this application.

FIG. 10 is a schematic structural diagram of an electronic device according to an embodiment of this application.

### DESCRIPTION OF EMBODIMENTS

The following describes the embodiments of this application with reference to the accompanying drawings. The following implementations described with reference to the accompanying drawings are exemplary descriptions for explaining the technical solutions of the embodiments of this application, and are not intended to limit the technical solutions of the embodiments of this application.

Those skilled in the art may understand that, unless specifically stated, singular forms “a”, “an”, “the”, and “this” used herein may also include plural forms. The terms “comprise” and “include” used in the embodiments of this application refer to corresponding features that can be implemented as presented features, information, data, operations, processes, elements, and/or components, but does not exclude the implementation of other features, information, data, operations, processes, elements, components, and/or combinations thereof supported in the art. One element is referred to as “connected” or “coupled” to another element, the element may be directly connected or coupled to another element, or may refer to a connection relationship established between the element and another element through an intermediate element. In addition, “connection” or “coupling” used herein may include wireless connection or wireless coupling. The term “and/or” used herein indicates at least one of the items defined by the term. For example, “A and/or B” indicates an implementation as “A”, an implementation as “B”, or an implementation as “A and B”.

To make the objectives, technical solutions, and advantages of this application clearer, the following further describes implementations of this application in detail with reference to the accompanying drawings.

First, terms involved in this application are introduced.

Haptics: it is a sensory experience, such as vibration, pressure, and temperature, obtained by the human body through touch.

Haptics media signal: it is configured for representing a haptics experience of a specific modality and is rendered and presented on a specific device.

JavaScript Object Notation (JSON): it is a lightweight data interchange format. It adopts a text format completely independent of a programming language to store and represent data. The simple and clear hierarchical structure makes JSON an ideal data exchange language. It is easy for humans to read and write, easy for machines to parse and generate, and effective in improving network transmission efficiency.

Bitstream or bit stream: it is a compressed and encoded binary data stream.

Track: it is a media data set in an encapsulation process of a media file, and includes a plurality of time-ordered samples. One media file may include at least one track. For example, one media file may include an audio media track, an audio media track, and a subtitle media track. Particularly, metadata information may also serve as a media type and is included in a file in the form of a metadata media track.

Sample: it is an encapsulation unit in an encapsulation process of a media file. A track includes a plurality of samples, and each sample corresponds to specific timestamp information. For example, one video media track may include a plurality of samples, and one sample is typically one video frame. In the embodiments of this application, one sample in a track may be at least one haptics signal.

Sample number: a number of a first sample in a track is 1.

Sample entry: it is configured for indicating metadata information related to all samples in a track. For example, a sample entry of a video track includes metadata information related to decoder initialization.

Sample group: it is configured for grouping some samples in a track based on a specific rule.

Media segment: it is a playable segment that conforms to a specific media format. During playback, the media segment may need to be used in conjunction with zero or a plurality of previous segments and an initialization segment.

In specific application, presentation of haptics information may be classified into the following categories:
vibrotactile presentation, direct haptics presentation in the form of vibrations;
kinesthetic presentation, simulating weight or pressure of an object; and
electrotactile presentation, simulating feedback information of a specific texture through electrical stimulation.

With the popularization of wearable devices and interactive devices, haptics presentation that can be perceived by a user during consumption of media content consumption is no longer limited to the foregoing three types of haptics presentation forms, but is comprehensive haptics including vibration, pressure, speed, acceleration, temperature, humidity, olfaction, and the like, which provides a full-body sensory experience that is closer to the real world.

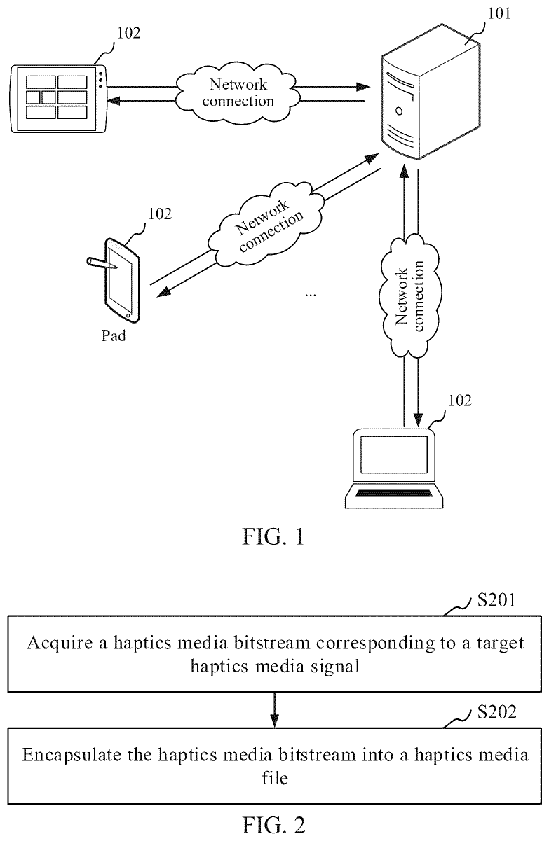

FIG. 1 is a structural diagram of a system for implementing a haptics media file encapsulation method and a haptics media decapsulation method according to an embodiment of this application. As shown in FIG. 1, the system may be an immersive system. The immersive system may include a server 101 and a plurality of terminal devices 102. The terminal device 102 may be a mobile phone, a pad, or another game device. The terminal devices may present a corresponding haptics media signal by using a corresponding sensor.

A service provider may collect or generate a related haptics media signal by using the server, encode and encapsulate the collected haptics media signal by using the server to obtain a corresponding haptics media file, and transmit the obtained haptics media file to a playing end. The received haptics media file is decapsulated and decoded by using the terminal device to obtain corresponding haptics media information. A user may perceive the haptics media information by using the terminal device. In this way, an immersive experience is achieved. A haptics media file encapsulation method provided in the embodiments of this application is adopted when an encapsulation operation is performed by using a server, and a haptics media file decapsulation method provided in the embodiments of this application is adopted when a decapsulation operation is performed by using a playing end.

FIG. 2 is a schematic flowchart of a haptics media file encapsulation method according to an embodiment of this application. The method may be performed by the server in FIG. 1. As shown in FIG. 2, the method includes the following operations:

Operation S201: Acquire a haptics media bitstream corresponding to a target haptics media signal.

The target haptics media signal is a to-be-encapsulated haptics media signal. Presentation of the haptics media signal may be vibrotactile presentation, kinesthetic presentation, electrotactile presentation, or the like. Specifically, the vibrotactile presentation refers to simulation of a vibration at a specific frequency and intensity through vibration of a motor of a terminal device. For example, in a shooting game, a particular effect of using a prop is simulated through vibration. The kinematic presentation refers to simulation of weight or pressure of an object by using a kinematic system. For example, in a driving video game, when a relatively heavy vehicle is moved at a relatively high speed or is operated, a steering wheel may resist turning. This type of feedback directly affects muscles of a user. In the example of the driving game, the user needs to apply more force to get a desired reaction from the steering wheel. The electrotactile presentation refers to providing haptics stimulation to nerve endings in the skin of a user through electric impulses. The electrotactile presentation may create a highly realistic experience for a user wearing a suit or a glove equipped with an electrotactile technology. Many sensations can be simulated through electrical impulses, such as a temperature change, a pressure change, and a sensation of moisture.

Specifically, the server collects or generates the target haptics media signal according to an expected haptics media effect. For example, if a particular effect of using a prop needs to be simulated through vibration in a shooting game, a corresponding vibrotactile signal is collected or generated. Then, the server converts an interchange format of the target haptics media signal into a specified interchange format, namely, a haptics media interchange format. The haptics media interchange format may be a JSON format. Then, the server compresses (that is, encodes) the target haptics media signal in the interchange format to obtain the corresponding haptics media bitstream (namely, a haptics media bit stream).

Operation S202: Encapsulate the haptics media bitstream into a haptics media file.

The haptics media file includes at least two tracks, each track includes haptics media data of at least one data type in the haptics media bitstream and first metadata of the haptics media data, the data type is obtained based on a preset data class, and the first metadata indicates the data type of the haptics media data. In addition, a plurality of tracks derived from a same haptics media bitstream may constitute a plurality of component tracks.

The preset data class may include one of a perception class, a channel class, a level class, and a priority class. In other words, the data may be classified into a perception type, a channel type, a level type, and a priority type. For example, if the preset data class is the perception class, the data type obtained based on the class may include vibration perception, temperature perception, or the like.

Specifically, after obtaining the haptics media bitstream through encoding, the server may further organize the haptics media bitstream, to obtain a haptics media transmission stream convenient for transmission, then encapsulate the haptics media transmission stream to obtain a plurality of tracks, and add corresponding first metadata to each track.

Specifically, after the haptics media bitstream (or the haptics media transmission stream corresponding to the haptics media bitstream) is acquired, the data types corresponding to the data in the haptics media bitstream are determined according to the preset data class. During each encapsulation, only one data class (namely, the preset class) is selected to determine the data types corresponding to the data in the haptics media bitstream.

Then, the data in the haptics media bitstream is encapsulated according to the data type to obtain the plurality of tracks. Each track includes data that is derived from the haptics media bitstream and that is of one or more data types.

Then, the corresponding first metadata is added to each track. The first metadata at least indicates the data type of the haptics media data in the track.

During decapsulation, the data type in each track may be determined according to the first metadata in the track, to further determine whether the data in the track is needed data.

For example, after the haptics media bitstream is acquired, the preset data class may be selected from the perception class, the channel class, the level class, and the priority class according to an actual requirement. For example, the “perception class” is selected as the preset data class. The data type of the data in the haptics media bitstream that is determined based on the preset data class includes: a perception type 1, a perception type 2 and a perception type 3. Then, the data is encapsulated according to the data type.

As shown in FIG. 3, data corresponding to the perception type 1, data corresponding to the perception type 2, and data corresponding to the perception type 3 may be respectively encapsulated within a track 1, a track 2, and a track 3, and corresponding first metadata that indicates that the data type of the haptics media data included in the track is the perception type 1 is added to the track 1, corresponding first metadata that indicates that the data type of the haptics media data included in the track is the perception type 2 is added to the track 2, and corresponding first metadata that indicates that the data type of the haptics media data included in the track is the perception type 3 is added to the track 3.

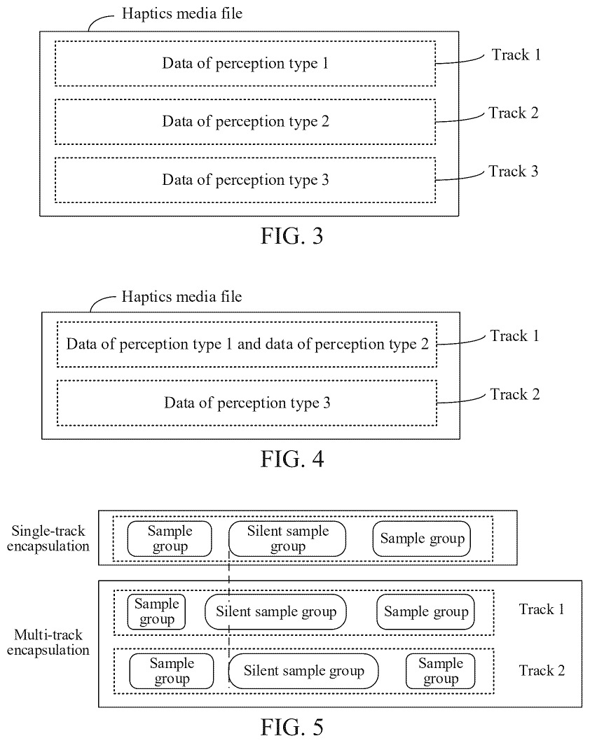

Alternatively, as shown in FIG. 4, two of the data types may be encapsulated within one track, and the other data type may be encapsulated within one track. For example, the data corresponding to the perception type 1 and the data corresponding to the perception type 2 may be encapsulated within the track 1, the data corresponding to the perception type 3 is encapsulated within the track 2, and corresponding first metadata that indicates that the data types of the haptics media data included in the track are the perception type 1 and the perception type 2 is added to the track 1, and corresponding first metadata that indicates the data type of the haptics media data included in the track is the perception type 3 is added to the track 2.

According to the solution provided in this application, after the haptics media bitstream corresponding to the target haptics media signal is acquired, the haptics media bitstream is encapsulated within the plurality of tracks according to the data type corresponding to the preset data class, whereby each track includes the data that is derived from the haptics media bitstream and that is of one or more data types and the first metadata that indicates the data type of the haptics media data included in the track. According to the solution, the haptics media bitstream is encapsulated within the plurality of tracks at the encapsulation stage, whereby a track that needs to be decoded can be selected according to the data type indicated in the first metadata of each track at the decoding stage. Therefore, flexibility of haptics media data application is improved.

In an embodiment of this application, the first metadata includes quantity information of data types and identification information of the data types of the haptics media data in the track.

Specifically, to indicate the data type of the haptics media data included in the track, the first metadata in each track may include the quantity information of the data types and the identification information of the data types. Specifically, the quantity information of the data types may indicate a quantity of data types included in the track, and the identification information of the data types may indicate specific data types included in the haptics media.

For example, for a track, quantity information of data types in first metadata of the track indicates that the track includes two data types, and identification information of the data types indicates that the data types of data in the track are respectively a perception type 1 and a perception type 2. Then, at the decapsulation stage, a quantity of data types included in the track is determined according to the quantity information of the data types in the first metadata of the track, and then whether the track needs to be decapsulated is determined according to the quantity of the data types. Further, a specific data type included in the track is determined based on the identification information of the data types in the first metadata of the track, and then whether the track needs to be decapsulated is determined according to the specific data type.

In an embodiment of this application, the preset data class may include one of the following: a perception class, a channel class, a level class, and a priority class.

In addition, a data type corresponding to the perception class may include vibration perception, temperature perception, and the like.

A channel in the channel class refers to a channel under a particular perception type. For example, vibration perception may have a plurality of different channels, and the different channels may correspond to apparatuses that are worn on different body parts and that are in a terminal devices used by a user. For example, a helmet is a channel under vibration perception, and a glove is another channel under vibration perception. Therefore, a data type corresponding to the channel class may include different channel types under a particular perception type.

A data type corresponding to the level class may include different level types, and these level types are divided into high and low levels. At the decapsulation stage, decapsulation needs to be sequentially performed from the low level to the high level. For example, for two tracks that are encapsulated according to the level type, if both the tracks need to be decapsulated at the decapsulation stage, the track of a lower-level type is first decapsulated, and then the track of a higher-level type is decapsulated.

The priority class may have different priority types, and these priority types are divided into high and low priorities. Similar to the level type, at the decapsulation stage, decapsulation needs to be sequentially performed from the high priority to the low priority.

In addition, the preset data class is not limited to the foregoing four classes, and another data class may be used according to requirements. The function of the preset data class is to set a uniform class to classify the data type of the data in the haptics media bitstream, whereby the data in the haptics media bitstream may be encapsulated within different tracks according to different data types at the encapsulation stage.

In an embodiment of this application, if the preset data class is the perception class, the first metadata further includes attribute information of the perception type of the haptics media data in the track.

Specifically, if the preset data class is the perception class, when the haptics media bitstream is encapsulated, each piece of data is encapsulated within different tracks according to the perception type of the haptics media data. It can be known from the foregoing descriptions that if the preset data class is the perception class, the first metadata of each track obtained through encapsulation may include quantity information of perception types and identification information of the perception types.

Further, the first metadata may include attribute information of the perception type. Specifically, the attribute information of the perception type may be a value, and the value corresponds to attribute information of one characteristic. For example, a mapping relationship is shown in Table 1.

TABLE 1

| Value corresponding to attribute information | Attribute information |
|---|---|
| 0 | Not defined |
| 1 | Pressure |
| 2 | Acceleration |
| 3 | Speed |
| 4 | Location |
| 5 | Temperature |
| 6 | Vibrotactile |
| 7 | Humidity |
| 8 | Wind |
| 9 | Kinesthetic |
| 10 | Haptics texture |
| 11 | Rigidity |
| 12 | Friction force |

In addition, an attribute of one perception type may correspond to at least one perception type. That is, an attribute of one perception type may correspond to an identifier of at least one perception type. For example, for perception types: a temperature type 1, a temperature type 2, and a temperature type 3, attributes of the perception types are all “temperature”.

In an embodiment of this application, if the preset data class is the channel class, the first metadata further includes channel group flag information of the haptics media data in the track. The channel group flag information indicates whether the haptics media data belongs to a same channel group.

Specifically, if the preset data class is the channel class, when the haptics media bitstream is encapsulated, each piece data is encapsulated within different tracks according to a channel type of the haptics media data. For a track including data of a plurality of channel types, first metadata of the track may further include channel group flag information. The channel group flag information indicates whether the plurality of channel types in the track belong to a same channel group. The channel group may be obtained through division in advance, and may provide richer data information for a subsequent decapsulation process, whereby flexibility of decapsulation is further improved.

Specifically, the channel group flag information may be a specific value. For example, if a value corresponding to the channel group flag information is 1, it indicates that the plurality of channel types in the track belong to a same channel group; and if a value corresponding to the channel group flag information is 0, it indicates that the plurality of channel types in the track do not belong to a same channel group.

In an embodiment of this application, the channel class further indicates a perception type, and the first metadata further includes identification information of the perception type and attribute information of the perception type of the haptics media data in the track.

Specifically, it can be known from the foregoing descriptions that one particular perception type may include a plurality of different channel types. Therefore, after the data in the haptics media bitstream is encapsulated within different tracks according to the channel types, information about the perception type information to which the included channel type belongs may be added to the first metadata corresponding to each track. Specifically, identification information of the perception type and attribute information of the perception type may be added.

In an embodiment of this application, the first metadata is stored in a data box corresponding to a track-level sample entry of the track, and includes indication information of the preset data class.

In a data structure of a track, first metadata of the track is stored in a data box corresponding to a sample entry.

Specifically, the track-level sample entry may be defined to indicate metadata information related to all samples in a track, such as a sample entry of a video track.

First metadata corresponding to each track may be specified in the data box of the track level sample entry. Indication information of the preset data class (or referred to as a component type), quantity information (or referred to as a component quantity) of data types, identification information of the data types, and other related information of the data types may be specified in the data box of the track-level sample entry.

The indication information of the preset data class may be a particular value, and each particular value corresponds to a particular preset data class. A mapping relationship is shown in Table 2.

TABLE 2

| Value | Preset data class |
|---|---|
| 0 | Perception class: a current track includes data of at least |
| | one different perception type in a haptics media bitstream. |
| 1 | Channel class: a current track includes data of at least one |
| | different channel type in a haptics media bitstream. |
| 2 | Level class: a current track includes data of at least one |
| | different level type in a haptics media bitstream. |
| 3 | Priority class: a current track includes data of at least one |
| | different priority type in a haptics media bitstream. |
| Other | Customized |

At the decapsulation stage, the corresponding preset data class may be determined based on the indication information of the preset data class in the first metadata in the sample entry of each track and Table 2.

In an embodiment of this application, the first metadata is stored in a data box corresponding to a data-type-level sample entry of the track, and the data box corresponding to the data-type-level sample entry includes indication information of the preset data class.

Specifically, the data-type-level sample entry may be defined to indicate metadata information related to all samples of a data type, such as a perception-type sample entry, a channel-type sample entry, a level-type sample entry, or a priority-type sample entry. Corresponding first metadata may be specified for each track in a data-type-level sample entry corresponding to the track. Compared with the track-level sample entry, the data-type-level sample entry itself can indicate an adopted preset data class. Therefore, quantity information of data types, identification information of the data types, and other related information of the data types may be specified in the data-type-level data box.

For example, if a track includes data of a perception type 1 and data of a perception type 2, and a track-level sample entry is adopted for the track, the following may be specified in a data box of the track-level sample entry:
indication information of a preset data class (or referred to as a component type): perception class;
quantity information (or referred to as a component quantity) of data types: 2;
identification information of the data types: perception type 1 and perception type 2; and
other related information of the data types: attribute of perception type.

If a data-type-level sample entry, namely, a perception-type sample entry, is adopted for the track, the following may be specified in a data box of the data-type-level sample entry:
quantity information of data types: 2;
identification information of the data types: perception type 1 and perception type 2; and
other related information of the data types: attribute of perception type.

In an embodiment of this application, the track includes at least one target sample group, and each target sample group includes one target sample or a plurality of consecutive target samples in the track.

Specifically, the data in the track is encapsulated in units of samples, and the track may include at least one target sample group. The corresponding track may be marked based on target sample group information. The target sample group information includes numbers of target samples.

In an embodiment of this application, the target sample does not include the haptics media data.

The target sample does not include the haptics media data, and may also be referred to as a silent sample. The corresponding target sample group may also be referred to as a silent sample group, and none of the samples included in the target sample group includes the haptics media data. At the decoding stage, the silent sample group may be directly skipped and does not need to be processed.

In the related art, although a silent unit is defined, and the silent unit in a haptics media bitstream indicates that no haptics signal is presented within a period of time, when the haptics media bitstream is encapsulated within a plurality of tracks, different tracks may have different silent times. As shown by a start moment marked by a dashed line in FIG. 5, during multi-track encapsulation, start moments of silent sample groups in a track 1 and a track 2 are different, and during single-track encapsulation of the track 1, the start moments of the silent sample groups are also different. Therefore, in the embodiments of this application, the silent sample group is defined to identify samples that do not include haptics signal data and that are in the track. Correspondingly, a type of a sample group is a silent sample group, and a sample is a silent sample, that is, the sample does not include haptics signal data and may be directly skipped during decoding.

In an embodiment of this application, the haptics media file further includes a metadata track, the metadata track includes second metadata of the haptics media bitstream, and the second metadata indicates encoding information of the haptics media bitstream. The encoding information refers to encoding parameters and configuration information used when the haptics media signal is compressed.

In an embodiment of this application, the track further includes second metadata of the haptics media bitstream, and the second metadata indicates encoding information of the haptics media bitstream.

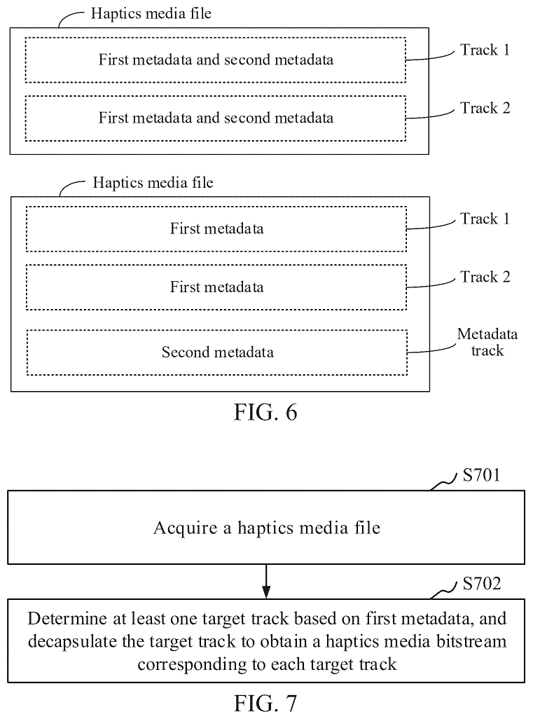

Specifically, as shown in FIG. 6, the second metadata may be separately encapsulated within a metadata track, and the metadata track needs to be first decapsulated and decoded at the decoding stage.

In other embodiments, each track may include one piece of second metadata. In this case, each track includes the first metadata and the second metadata.

FIG. 7 is a schematic flowchart of a haptics media file decapsulation method according to an embodiment of this application. The method may be performed by the terminal device in FIG. 1. As shown in FIG. 7, the method includes the following operations.

Operation S701: Acquire a haptics media file.

The haptics media file includes at least two tracks, each track includes haptics media data of at least one data type in a haptics media bitstream and first metadata of the haptics media data, the data type is obtained based on a preset data class, and the first metadata indicates the data type of the haptics media data.

The preset data class may include one of a perception class, a channel class, a level class, and a priority class. In other words, the data may be classified into a perception type, a channel type, a level type, and a priority type. For example, if the preset data class is the perception class, the data type obtained based on the class may include vibration perception, temperature perception, or the like.

Specifically, the haptics media file is acquired from a server, and the server obtains the haptics media file in the following manner:
after obtaining the haptics media bitstream through encoding, the server may further organize the haptics media bitstream to obtain a haptics media transmission stream convenient for transmission, then encapsulate the haptics media transmission stream to obtain a plurality of tracks, and add corresponding first metadata to each track.

Specifically, after the haptics media bitstream (or the haptics media transmission stream corresponding to the haptics media bitstream) is acquired, the data types corresponding to the data in the haptics media bitstream are determined according to the preset data class. During each encapsulation, only one data class (namely, the preset class) is selected to determine the data types corresponding to the data in the haptics media bitstream.

Then, the data in the haptics media bitstream is encapsulated according to the data type to obtain the plurality of tracks. Each track includes data that is derived from the haptics media bitstream and that is of one or more data types.

Then, the corresponding first metadata is added to each track. The first metadata at least indicates the data type of the haptics media data in the track.

During decapsulation, the data type in each track may be determined according to the first metadata in the track, to further determine whether the data in the track is needed data.

For processing at a server side, refer to the description of the embodiment shown in FIG. 2. Details are not described herein again.

Operation S702: Determine at least one target track based on first metadata, and decapsulate the target track to obtain a haptics media bitstream corresponding to each target track.

Specifically, the terminal device determines the target track from the tracks according to the first metadata in the tracks, as well as a device capability of the terminal device and/or a usage preference of a user. The device capability refers to a capability of the terminal device to support the data type under the preset data class, and the usage preference of the user refers to haptics presentation of a data type used by the user.

Then, the target track is decapsulated, to obtain the corresponding haptics media bitstream, further the obtained haptics media bitstream is decoded, to obtain a haptics media signal in a target interchange format, and rendering and presentation are performed.

According to the solution provided in this application, after the haptics media bitstream corresponding to the target haptics media signal is acquired, the haptics media bitstream is encapsulated within the plurality of tracks according to the data type corresponding to the preset data class, whereby each track includes the data that is derived from the haptics media bitstream and that is of one or more data types and the first metadata that indicates the data type of the haptics media data included in the track. According to the solution, the haptics media bitstream is encapsulated within the plurality of tracks at the encapsulation stage, whereby a track that needs to be decoded can be selected according to the data type indicated in the first metadata of each track at the decoding stage. Therefore, flexibility of haptics media data application is improved.

The following describes the haptics media file encapsulation and decapsulation method in the embodiments of this application by using an example. The method may include:

(1) A server generates or collects a haptics media signal according to an expected haptics media effect, and converts an interchange format of a target haptics media signal into a specified interchange format.

(2) The server compresses the haptics media signal in the interchange format into a haptics media bitstream.

(3) The server organizes the haptics media bitstream, to form a transmission stream convenient for transmission.

(4) The server encapsulates the transmission stream into a haptics media file, and the file includes two tracks, which are respectively denoted as a track 1 and a track 2, and respectively correspond to a vibration perception type and a temperature perception type. A corresponding track includes the following first metadata:

Track 1: a sample entry type is a track-level sample entry, and the following information is specified in a data box of the sample entry:
{indication information of preset data class=0; a quantity of data types=1; identification information of perception type=1; and attribute information of perception type=5}

In addition, the sample entry of the track 1 includes second metadata.

Meanwhile, silent samples in the track 1 are identified by using silent sample group information, and are assumed to be a sample 100 to a sample 200.

Track 2: a sample entry type is a data-type-level sample entry, and the following information is specified in a data box of the sample entry: {indication information of preset data class=0; a quantity of data types=1; identification information of perception type=2; and attribute information of perception type=6}

In addition, the sample entry of the track 2 repeatedly includes the second metadata.

Meanwhile, silent samples in the track 2 are identified by using silent sample group information, and are assumed to be a sample 100 to a sample 400.

(5) The server may slice the haptics media file, to obtain a plurality of haptics media file segments, and each haptics media file segment includes complete first metadata and second metadata.

(6) A terminal device acquires the haptics media file or the haptics media file segments.

(7) After the terminal device selects a corresponding track (namely, a target track) according to the metadata in the haptics media file or the haptics media file segments, as well as a device capability of the terminal device, a usage preference of a user, and the like, decapsulates and decodes the corresponding track, to obtain a haptics media signal in an interchange format, and performs rendering and presentation.

For example, a device of a user 1 does not support temperature-related haptics presentation. Therefore, only the haptics media data in the track 2 is decoded for presentation. In addition, according to the information about the silent sample group, the sample 100 to the sample 400 are directly skipped and are not decoded.

For example, if a device of a user 2 supports the perception types corresponding to the track 1 and the track 2, the haptics media data in the track 1 and the track 2 is decoded for presentation. In addition, according to the information about the silent sample group, the sample 100 to the sample 200 in the track 1 and the sample 100 to the sample 400 in the track 2 are skipped and are not decoded.

Particularly, in a streaming transmission mode, for the user 1, a media resource corresponding to the track 2 may be transmitted, to further save bandwidth resources.

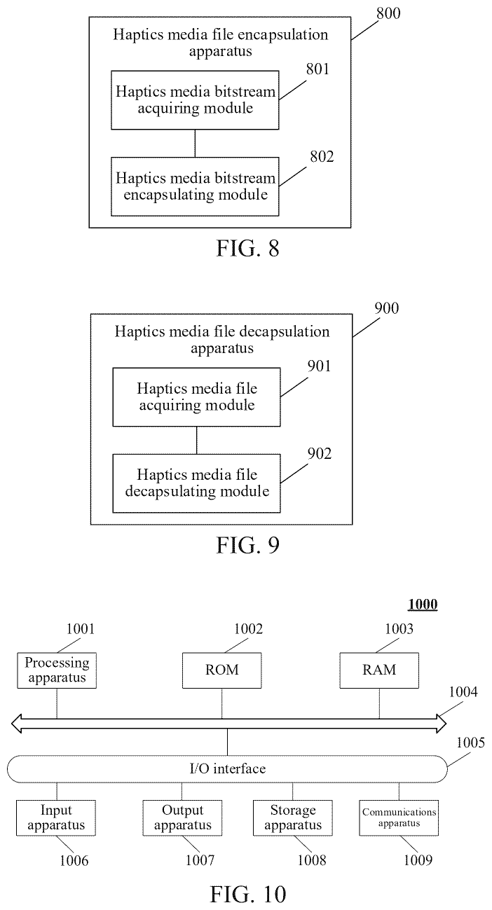

FIG. 8 is a schematic structural diagram of a haptics media file encapsulation apparatus according to an embodiment of this application. As shown in FIG. 8, an apparatus 800 includes: a haptics media bitstream acquiring module 801 and a haptics media bitstream encapsulating module 802.

The haptics media bitstream acquiring module 801 is configured to acquire a haptics media bitstream corresponding to a target haptics media signal.

The haptics media bitstream encapsulating module 802 is configured to encapsulate the haptics media bitstream into a haptics media file.

The haptics media file includes at least two tracks, each track includes haptics media data of at least one data type in the haptics media bitstream and first metadata of the haptics media data, the data type is obtained based on a preset data class, and the first metadata indicates the data type of the haptics media data.

According to the solution provided in this application, after the haptics media bitstream corresponding to the target haptics media signal is acquired, the haptics media bitstream is encapsulated within the plurality of tracks according to the data type corresponding to the preset data class, whereby each track includes the data that is derived from the haptics media bitstream and that is of one or more data types and the first metadata that indicates the data type of the haptics media data included in the track. According to the solution, the haptics media bitstream is encapsulated within the plurality of tracks at the encapsulation stage, whereby a track that needs to be decoded can be selected according to the data type indicated in the first metadata of each track at the decoding stage. Therefore, flexibility of haptics media data application is improved.

In an embodiment of this application, the first metadata includes quantity information of data types and identification information of the data types of the haptics media data in the track.

In an embodiment of this application, the preset data class includes one of the following: a perception class, a channel class, a level class, and a priority class.

In an embodiment of this application, if the preset data class is the perception class, the first metadata further includes attribute information of the perception type of the haptics media data in the track.

In an embodiment of this application, if the preset data class is the channel class, the first metadata further includes channel group flag information of the haptics media data in the track, and the channel group flag information indicates whether the data belongs to a same channel group.

In an embodiment of this application, the channel class further indicates a perception type; and the first metadata further includes identification information of the perception type of the haptics media data in the track and attribute information of the perception type.

In an embodiment of this application, the first metadata is stored in a data box corresponding to a track-level sample entry of the track, and includes indication information of the preset data class.

In an embodiment of this application, the first metadata is stored in a data box corresponding to a data-type-level sample entry of the track, and the data box corresponding to the data-type-level sample entry includes indication information of the preset data class.

In an embodiment of this application, the track includes at least one target sample group, and each target sample group includes one target sample or a plurality of consecutive target samples in the track.

In an embodiment of this application, the target sample does not include the haptics media data.

In an embodiment of this application, the haptics media file further includes a metadata track, the metadata track includes second metadata of the haptics media bitstream, and the second metadata indicates encoding information of the haptics media bitstream.

In an embodiment of this application, the track further includes second metadata of the haptics media bitstream, and the second metadata indicates encoding information of the haptics media bitstream.

FIG. 9 is a structural block diagram of a haptics media file decapsulation apparatus according to an embodiment of this application. As shown in FIG. 9, an apparatus 900 includes: a haptics media file acquiring module 901 and a haptics media file decapsulating module 902.

The haptics media file acquiring module 901 is configured to acquire a haptics media file, the haptics media file including at least two tracks, each track including data of at least one data type in a haptics media bitstream and first metadata of the haptics media data, the data type being obtained based on a preset data class, and the first metadata indicating the data type of the haptics media data.

The haptics media file decapsulating module 902 is configured to determine at least one target track based on the first metadata, and decapsulate the target track to obtain a haptics media bitstream corresponding to each target track.

According to the solution provided in this application, after the haptics media bitstream corresponding to the target haptics media signal is acquired, the haptics media bitstream is encapsulated within the plurality of tracks according to the data type corresponding to the preset data class, whereby each track includes the data that is derived from the haptics media bitstream and that is of one or more data types and the first metadata that indicates the data type of the haptics media data included in the track. According to the solution, the haptics media bitstream is encapsulated within the plurality of tracks at the encapsulation stage, whereby a track that needs to be decoded can be selected according to the data type indicated in the first metadata of each track at the decoding stage. Therefore, flexibility of haptics media data application is improved.

The apparatus provided in the embodiments of this application may perform the method provided in the embodiments of this application, and the implementation principles of the apparatus and the method are similar. The actions performed by the modules in the apparatus provided in the embodiments of this application correspond to the operations in the method provided in the embodiments of this application. For a detailed functional description of the modules of the apparatus, refer to the description of the corresponding method mentioned above. Details are not described herein again.

FIG. 10 is a schematic structural diagram of an electronic device 1000 (such as a terminal device or a server that performs the method shown in FIG. 2 or FIG. 7) adapted to implement the embodiments of this application. The electronic device provided in the embodiments of this application may include, but is not limited to, mobile terminals such as a mobile phone, a notebook computer, a digital broadcast receiver, a personal digital assistant (PDA), a pad, a portable multimedia player (PMP), an on-board terminal (such as an on-board navigation terminal), and a wearable device, and fixed terminals such as a digital television (TV) and a desktop computer. The electronic device shown in FIG. 10 is merely an example, and does not constitute any limitation on functions and usage scope of the embodiments of this application.

The electronic device includes: a memory and a processor, the memory being configured to store a program for performing the method provided in the foregoing method embodiments; and the processor being configured to execute the program stored in the memory. The processor herein may be referred to as a processing apparatus 1001 described below, and the memory may include at least one of a read-only memory (ROM) 1002, a random-access memory (RAM) 1003, and a storage apparatus 1008 described below. Details are as follows:

As shown in FIG. 10, the electronic device 1000 may include the processing apparatus (such as a central processing unit (CPU) or a graphics processing unit) 1001, which may perform various appropriate actions and processing according to a program stored in the ROM 1002 or a program loaded into the RAM 1003 from the storage apparatus 1008. The RAM 1003 further has various programs and data required for operation of the electronic device 1000. The processing apparatus 1001, the ROM 1002, and the RAM 1003 are connected to each other through a bus 1004. An input/output (I/O) interface 1005 is also connected to the bus 1004.

Typically, the following apparatuses may be connected to the I/O interface 1005: an input apparatus 1006 including, for example, a touchscreen, a touchpad, a keyboard, a mouse, a camera, a microphone, an accelerometer, or a gyroscope; an output apparatus 1007 including, for example, a liquid crystal display (LCD), a speaker, and a vibrator; the storage apparatus 1008 including a magnetic tape, a hard disk, or the like; and a communications apparatus 1009. The communications apparatus 1009 may allow the electronic device 1000 to perform wireless or wired communication with another device to exchange data. Although FIG. 10 shows the electronic device having various apparatuses, not all the illustrated apparatuses are required to be implemented or to be provided. Alternatively, more or fewer apparatus may be implemented or included.

Particularly, according to the embodiments of this application, the processes described above with reference to the flowchart may be implemented as a computer software program. For example, the embodiments of this application include a computer program product, which includes a computer program carried on a non-transient computer-readable medium. The computer program includes program code configured for performing the method shown in the flowchart. In such an embodiment, the computer program may be downloaded and installed through the communication apparatus 1009 over a network, or installed from the storage apparatus 1008, or installed from the ROM 1002. The processing apparatus 1001 executes the computer program, to perform the foregoing functions defined in the method provided in the embodiments of this application.

In addition, the computer-readable medium of this application may be a computer-readable signal medium, a non-transitory computer-readable storage medium, or any combination thereof. The computer-readable storage medium may be, for example, but is not limited to, an electric, magnetic, optical, electromagnetic, infrared, or semi-conductive system, apparatus, or component, or any combination of the above. More specific examples of the computer-readable storage medium may include, but are not limited to, an electrical connection having at least one conductor, a portable computer disk, a hard disk, an RAM, an ROM, an erasable programmable ROM (EPROM or flash memory), an optical fiber, a portable compact disc ROM (CD-ROM), an optical storage device, a magnetic storage device, or any appropriate combination thereof. In this application, the computer-readable storage medium may be any tangible medium containing or storing a program, and the program may be used by or used in combination with an instruction execution system, an apparatus, or a device. In this application, the computer-readable signal medium may include a data signal being in a baseband or propagated as a part of a carrier wave, the data signal carrying computer-readable program code. A data signal propagated in such a way may assume a plurality of forms, including but not limited to, an electromagnetic signal, an optical signal, or any appropriate combination thereof. The computer-readable signal medium may further be any computer-readable medium rather than the computer-readable storage medium. The computer-readable medium may transmit, propagate, or transfer a program that is used by or used in combination with an instruction execution system, an apparatus, or a device. The program code included in the computer-readable medium may be transmitted by any appropriate medium, including but not limited to, a wire, a fiber optic cable, radio frequency (RF), or any appropriate combination thereof.

In some implementations, the terminal device and the server may communicate by using any network protocol currently known or developed in the future such as the HyperText Transfer Protocol (HTTP), and may be interconnected with digital data communication (such as a communications network) in any form or medium. Examples of the communications network include a local area network (“LAN”), a wide area network (“WAN”), an Internet (such as the Internet), a peer-end network (such as an ad hoc peer-to-peer network), and any network currently known or developed in the future.

The computer-readable medium may be included in the electronic device; or may exist alone without being assembled into the electronic device.

The computer-readable medium carries one or more programs, and the electronic device executes the one or more programs, to perform the following operations:
acquiring a haptics media bitstream corresponding to a target haptics media signal; and encapsulating the haptics media bitstream into a haptics media file, the haptics media file including at least two tracks, each track including haptics media data of at least one data type in the haptics media bitstream and first metadata of the haptics media data, the data type being obtained based on a preset data class, and the first metadata indicating the data type of the haptics media data; or
acquiring a haptics media file, the haptics media file including at least two tracks, each track including data of at least one data type in a haptics media bitstream and first metadata of the haptics media data, the data type being obtained based on a preset data class, and the first metadata indicating the data type of the haptics media data; and determining at least one target track based on the first metadata, and decapsulating the target track to obtain a haptics media bitstream corresponding to each target track.

The computer program code configured for performing the operations in this application may be written in one or more programming languages or any combination thereof. The programming language includes, but is not limited to, an object-oriented programming language such as Java, Smalltalk, or C++, and a conventional procedural programming language such as the “C” language or a similar programming language. The program code may be completely executed on a user computer, partially executed on a user computer, executed as an independent software package, partially executed on a user computer and partially executed on a remote computer, or completely executed on a remote computer or server. In a case involving the remote computer, the remote computer may be connected to the user computer through any type of network including an LAN or a WAN, or may be connected to an external computer (for example, connected to the external computer through the Internet by using an Internet service provider).

The flowcharts and block diagrams in the accompanying drawings illustrate possible system architectures, functions, and operations that may be implemented by the system, the method, and the computer program product according to various embodiments of this application. Based on this, each block in the flowchart or the block diagram may represent a module, a program segment, or part of code. The module, the program segment, or the part of the code includes at least one executable instruction for implementing specified logical functions. In some alternative implementations, functions annotated in boxes may occur in a sequence different from that annotated in the accompanying drawing. For example, actually two boxes shown in succession may be performed basically in parallel, and sometimes the two boxes may be performed in a reverse sequence. This is determined by a related function. Each box in the block diagram and/or the flowchart and a combination of boxes in the block diagram and/or the flowchart may be implemented by using a dedicated hardware-based system configured to perform a specified function or operation, or may be implemented by using a combination of dedicated hardware and a computer instruction.

The modules or units described in the embodiments of this application may be implemented in the form of software or hardware. Names of the modules or units do not constitute a limitation on the units in a specific case. For example, a first constraint acquiring module may further be described as a “module that acquires a first constraint”.

The functions described above may be at least partially performed by at least one hardware logic component. For example, without limitation, exemplary types of hardware logic components that may be used include: a field programmable gate array (FPGA), an application-specific integrated circuit (ASIC), an application-specific standard product (ASSP), a system on a chip (SOC), a complex programmable logic device (CPLD), and the like.

In the context of this application, a machine-readable medium may be a tangible medium that may include or store a program used by or used in combination with an instruction execution system, apparatus, or device. The machine-readable medium may be a machine-readable signal medium or a machine-readable storage medium. The machine-readable medium may include, but is not limited to, an electric, magnetic, optical, electromagnetic, infrared, or semi-conductive system, apparatus, or device, or any appropriate combination thereof. More specific examples of the machine-readable storage medium include: an electrical connection having at least one conductor, a portable computer disk, a hard disk, an RAM, an ROM, an EPROM or flash memory, an optical fiber, a CD-ROM, an optical storage device, a magnetic storage device, or any appropriate combination thereof.

The embodiments of this application provide a computer program product or a computer program, which includes computer instructions. The computer instructions are stored in a non-transitory computer-readable storage medium. A processor of a computer device reads the computer instructions from the computer-readable storage medium, and executes the computer instructions, to cause the computer device to perform the following operations:
acquiring a haptics media bitstream corresponding to a target haptics media signal; and encapsulating the haptics media bitstream into a haptics media file, the haptics media file including at least two tracks, each track including haptics media data of at least one data type in the haptics media bitstream and first metadata of the haptics media data, the data type being obtained based on a preset data class, and the first metadata indicating the data type of the haptics media data; or
acquiring a haptics media file, the haptics media file including at least two tracks, each track including data of at least one data type in a haptics media bitstream and first metadata of the haptics media data, the data type being obtained based on a preset data class, and the first metadata indicating the data type of the haptics media data; and determining at least one target track based on the first metadata, and decapsulating the target track to obtain a haptics media bitstream corresponding to each target track.

Although the operations in the flowchart in the accompanying drawings are sequentially shown according to indication of an arrow, the operations are not necessarily sequentially performed according to a sequence indicated by the arrow. Unless explicitly specified herein, execution of the operations is not strictly limited in the sequence, and the operations may be performed in other sequences. In addition, at least some operations in the flowchart in the accompanying drawings may include a plurality of sub-operations or a plurality of stages. The sub-operations or the stages are not necessarily performed at the same moment, but may be performed at different moments. The sub-operations or the stages are not necessarily performed in sequence, but may be performed in turn or alternately with another operation or at least some of sub-operations or stages of the another operation.

The above are some implementations of this application. Those of ordinary skill in the art may further make several improvements and modifications without departing from the principle of this application and these improvements and modifications still fall within the scope of protection of this application.

What is claimed is:

1. A haptics media file encapsulation method, the method comprising:
acquiring a haptics media bitstream corresponding to a target haptics media signal; and
encapsulating the haptics media bitstream into a haptics media file,
wherein the haptics media file comprises at least two tracks, each track comprising haptics media data of at least one data type in the haptics media bitstream based on a preset data class and a first metadata of the haptics media data indicating the data type of the haptics media data.

2. The method according to claim 1, wherein the first metadata comprises quantity information of data types and identification information of the data types of the haptics media data in the track.

3. The method according to claim 2, wherein the preset data class comprises at least one of the following: a perception class, a channel class, a level class, and a priority class.

4. The method according to claim 3, wherein when the preset data class is the perception class, the first metadata further comprises attribute information of a perception type of the haptics media data in the track.

5. The method according to claim 3, wherein when the preset data class is the channel class, the first metadata further comprises channel group flag information of the haptics media data in the track, and the channel group flag information indicates whether the haptics media data belongs to a same channel group.

6. The method according to claim 5, wherein the channel class further indicates a perception type of the haptics media data in the track, and the first metadata further comprises identification information of the perception type and attribute information of the perception type of the haptics media data in the track.

7. The method according to claim 1, wherein the first metadata is stored in a data box corresponding to a track-level sample entry of the track, and the first metadata comprises indication information of the preset data class.

8. The method according to claim 1, wherein the first metadata is stored in a data box corresponding to a data-type-level sample entry of the track, and the data box corresponding to the data-type-level sample entry comprises indication information of the preset data class.

9. The method according to claim 1, wherein the track comprises at least one target sample group, and each target sample group comprises one target sample or a plurality of consecutive target samples in the track.

10. The method according to claim 9, wherein the target sample does not comprise haptics media data.

11. The method according to claim 1, wherein the haptics media file further comprises a metadata track, the metadata track comprises a second metadata of the haptics media bitstream, and the second metadata indicates encoding information of the haptics media bitstream.

12. The method according to claim 1, wherein the track further comprises a second metadata of the haptics media bitstream, and the second metadata indicates encoding information of the haptics media bitstream.

13. An electronic device, comprising a memory and a processor,
the memory having a computer program stored therein; and
the processor, when executing the computer program, causing the electronic device to implement a haptics media file encapsulation method including:
acquiring a haptics media bitstream corresponding to a target haptics media signal; and
encapsulating the haptics media bitstream into a haptics media file,
wherein the haptics media file comprises at least two tracks, each track comprising haptics media data of at least one data type in the haptics media bitstream based on a preset data class and first metadata of the haptics media data indicating the data type of the haptics media data.

14. The electronic device according to claim 13, wherein the first metadata comprises quantity information of data types and identification information of the data types of the haptics media data in the track.

15. The electronic device according to claim 13, wherein the first metadata is stored in a data box corresponding to a track-level sample entry of the track, and the first metadata comprises indication information of the preset data class.

16. The electronic device according to claim 13, wherein the first metadata is stored in a data box corresponding to a data-type-level sample entry of the track, and the data box corresponding to the data-type-level sample entry comprises indication information of the preset data class.

17. The electronic device according to claim 13, wherein the track comprises at least one target sample group, and each target sample group comprises one target sample or a plurality of consecutive target samples in the track.

18. The electronic device according to claim 13, wherein the haptics media file further comprises a metadata track, the metadata track comprises second metadata of the haptics media bitstream, and the second metadata indicates encoding information of the haptics media bitstream.

19. The electronic device according to claim 13, wherein the track further comprises second metadata of the haptics media bitstream, and the second metadata indicates encoding information of the haptics media bitstream.

20. A non-transitory computer-readable storage medium, having a computer program stored therein, the computer program, when executed by a processor of a computer device, causing the computer device to implement a haptics media file encapsulation method including:
acquiring a haptics media bitstream corresponding to a target haptics media signal; and
encapsulating the haptics media bitstream into a haptics media file,
wherein the haptics media file comprises at least two tracks, each track comprising haptics media data of at least one data type in the haptics media bitstream based on a preset data class and first metadata of the haptics media data indicating the data type of the haptics media data.
